(19) United States
(12) Patent Application Publication
(10) Pub. No.: US 2007/0256036 A1
(43) Pub. Date: Nov. 1, 2007

(54) User interface having integer and fraction display

(76) Inventors: Eric Scott Johnson, Louisville, KY (US); Natarajan Venkatakrishnan, Louisville, KY (US); Ramesh Janardhanam, Louisville, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(21) Appl. No.: 11/413,390

(22) Filed: Apr. 28, 2006

(51) Int. Cl. G06F 3/00

(52) U.S. Cl. 715/866

(57) ABSTRACT

A user interface for an appliance is provided. The user interface is operatively coupled to a controller configured to control operation of the appliance in a consumer input mode, wherein at least one operating parameter is selectable by the consumer. The user interface includes a display panel having an integer display portion and a fraction display portion. The user interface is configured to independently select an integer portion of the at least one operating parameter and a fraction portion of the at least one operating parameter. The user interface is in operational communication with the controller and configured to transmit a signal to the controller indicating the at least one selected operating parameter.

### BACKGROUND OF THE INVENTION

This invention relates generally to user interfaces for appliances and, more particularly, to user interfaces having display panels with independently adjustable display portions.

Some conventional appliances, such as microwaves, ranges, refrigerators, washing machines, dryers and dishwashers, include user interfaces. The user interfaces may include a display panel that displays one or more appliance operating parameters. In order for the consumer to adjust such operating parameters, the consumer is required to cycle through a list of options in order to select the desired operating parameter. Such adjustment may be time consuming.

### BRIEF DESCRIPTION OF THE INVENTION

In one aspect, a user interface for an appliance is provided. The user interface is operatively coupled to a controller configured to control operation of the appliance in a consumer input mode wherein at least one operating parameter is selectable by the consumer. The user interface includes a display panel having an integer display portion and a fraction display portion. The user interface is configured to independently select an integer portion of the at least one operating parameter and a fraction portion of the at least one operating parameter. The user interface is in operational communication with the controller and configured to transmit a signal to the controller indicating the at least one selected operating parameter.

In another aspect, an appliance is provided. The appliance includes a cabinet. A user interface is coupled to the cabinet and configured for selection of at least one operating parameter in a consumer input mode. The user interface includes a display panel having an integer display portion and a fraction display portion. The user interface is configured to independently select an integer portion of the at least one operating parameter and a fraction portion of the at least one operating parameter. A controller is in operational communication with the user interface. The controller is configured to control operation of the appliance in response to the at least one operating parameter selected by the consumer.

In another aspect, a method is provided for selecting at least one operating parameter of an appliance in a consumer input mode. The method includes displaying at least one of an integer portion and a fraction portion of the at least one operating parameter on a display panel of a user interface. The user interface is in operational communication with a controller configured to control operation of the appliance. At least one of the integer portion and the fraction portion is independently adjusted. A signal indicating the at least one selected operating parameter is transmitted to the controller.

### BRIEF DESCRIPTION OF THE DRAWINGS

FIG. 1 is a schematic view of an exemplary appliance according to one embodiment.

FIG. 2 is a schematic view of a user interface suitable for use with the appliance shown in FIG. 1.

FIG. 3 is a schematic view of a water dispensing system for an appliance according to one embodiment.

FIG. 4 illustrates a side-by-side refrigerator.

FIG. 5 is front view of the refrigerator shown in FIG. 4.

FIG. 6 is a sectional view of an exemplary ice maker using the water dispensing system.

FIG. 7 is a schematic view of a control system for use with the appliance shown in FIG. 4.

FIG. 8 is a front view of a user interface for use with the water dispensing system shown in FIG. 4.

FIG. 9 is a flow diagram showing an exemplary control method for the water dispensing system shown in FIG. 4.

### DETAILED DESCRIPTION OF THE INVENTION

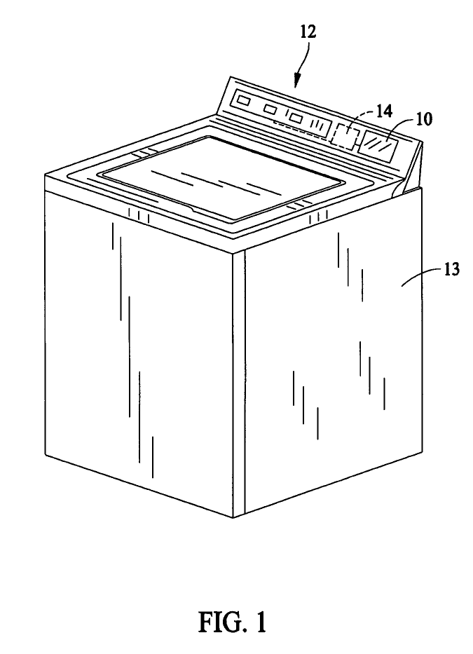

The present invention provides a user interface 10 for an appliance 12. Appliance 12 may be any suitable household or industrial appliance including, without limitation, a microwave, a range, a refrigerator, a washing machine, a dryer or a dishwasher. As shown in FIG. 1, appliance 12 generally includes a cabinet 13 to which user interface 10 is coupled. User interface 10 is operatively coupled to a controller 14 that is configured to control operation of appliance 12 in a plurality of operating modes. In one embodiment, controller 14 is implemented as a microprocessor. The term microprocessor as used hereinafter is not limited just to microprocessors, but broadly refers to computers, processors, microcontrollers, microcomputers, programmable logic controllers, application specific integrated circuits and other programmable logic circuits, and these terms are used interchangeably herein.

In one embodiment, appliance 12 is selectively operable in a first or normal operating mode and a second or consumer input mode. In the consumer input mode, the consumer is able to control operation of appliance 12. More specifically, user interface 10 allows the consumer to select and/or adjust at least one operating parameter for operation of appliance 12, as desired by the consumer. In a particular embodiment, using user interface 10, the consumer selects an operating parameter and adjusts the operating parameter as the consumer desires using at least one input component, as described in greater detail below. The operating parameter may include a weight of a food item for cooking or thawing in a microwave, a quantity of detergent or other laundry additive added to a washing machine or a volume of water dispensed from an appliance water dispensing system, for example.

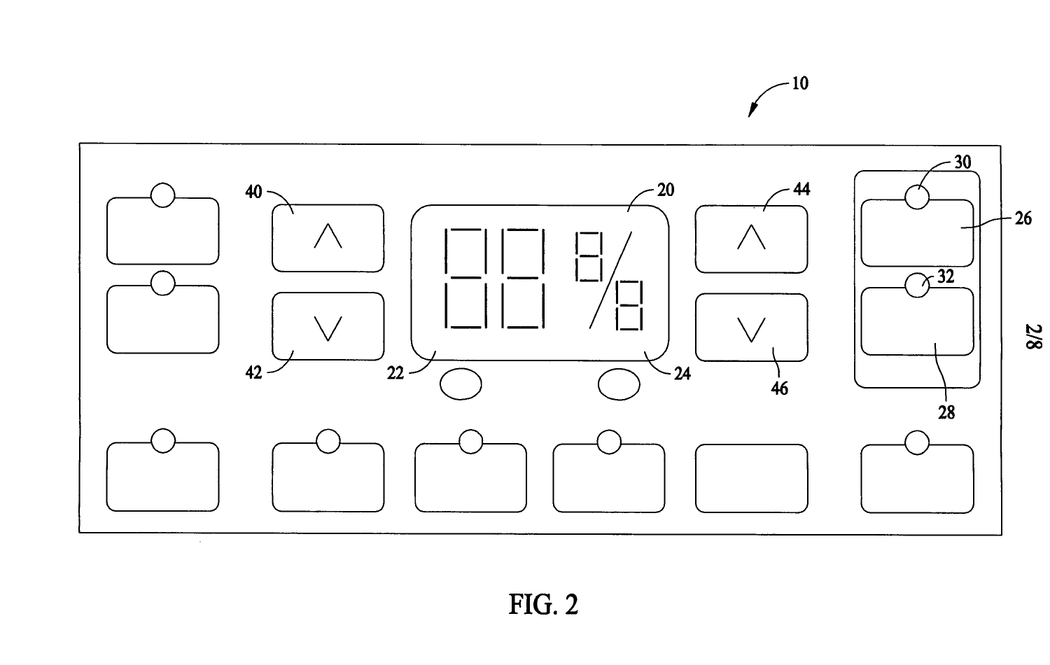

As shown in FIG. 2, user interface 10 includes a display panel 20 having an integer display portion 22 and a fraction or decimal display portion, referred to herein as fraction display portion 24. User interface 10 and/or display panel 20 are configured to independently select an integer portion of the operating parameter and a fraction portion of the operating parameter. User interface 10 is in operational communication with controller 14 and is configured to transmit a signal to controller 14 or otherwise indicate to controller 14 the selected and/or adjusted operating parameter.

As shown in FIG. 2, user interface 10 includes at least one operating parameter selection component 26, 28 to facilitate the consumer in selecting at least one operating parameter for adjustment, as desired by the consumer. In one embodiment, an indicator 30 or 32, respectively, is configured to indicate the operating parameter selected by activating operating parameter selection component 26 or 28. It is apparent to those skilled in the art and guided by the teachings herein provided that user interface 10 may include any suitable number of operating parameter selection components and/or corresponding indicators. Further, user interface 10 may include any suitable additional or alternative components for selecting features and/or operating modes and parameters of appliance 12.

User interface 10 includes at least one input component that is operatively coupled to integer display portion 22 and/or fraction display portion 24. The at least one input component is configured to select the integer portion and/or the fraction portion of the operating parameter selected using operating parameter selection component 26, 28. In alternative embodiments, the input component includes a button, a switch, a touchpad, a LCD or any suitable component known to those skilled in the art and guided by the teachings herein provided suitable for selecting and/or adjusting the integer portion and/or the fraction portion of the selected operating parameter. In one embodiment, user interface 10 includes a switching component (not shown) that is operatively coupled to the at least one input component to select and/or adjust the integer portion and/or the fraction portion. In this embodiment, the switching component allows one input component or one set of input components to independently select and/or adjust the integer portion and the fraction portion.

As shown in FIG. 2, a first input component 40 and a second input component 42 are operatively coupled to integer display portion 22 to adjust the integer portion of the operating parameter. In this embodiment, first input component 40 is an increment adjustment component and second input component 42 is a decrement adjustment component. First input component 40 and/or second input component 42 adjust integer display portion 22 to display a blank screen or an integer, such as an integer within a range of “1” and “99”. Similarly, a third input component 44 and/or a fourth input component 46 are operatively coupled to fraction display portion 24 to adjust the fraction portion of the operating parameter. In this embodiment, third input component 44 is an increment adjustment component and fourth input component 46 is a decrement adjustment component. Third input component 44 and/or fourth input component 46 adjust fraction display portion 24 to display a blank screen, a decimal, such as within a range of “0.01” and “0.99”, and a fraction, such as “⅛”, “¼”, “⅓”, “⅜”, “½”, “⅝”, “⅔”, “ 3/4”, or “⅞”. It is apparent to those skilled in that art and guided by the teachings herein provided that integer display portion 22 may display an integer within any suitable range and/or fraction display portion 24 may display any fraction or decimal within any suitable range.

In one embodiment, a method for selecting at least one operating parameter of an appliance in a consumer input mode is provided. The method includes activating the consumer input mode on a user interface. In a particular embodiment, upon activating the consumer input mode, a last-used operating mode and/or a last-used selected operating parameter is indicated by the user interface. The user interface is in operational communication with a controller configured to control operation of the appliance. An operating parameter is selected from a plurality of operating parameters indicated on the user interface. Upon selecting the operating parameter, the user interface indicates to the consumer the selected operating parameter. An integer portion and/or a fraction portion of the operating parameter are displayed on a display panel of the user interface.

In one embodiment, the integer portion and/or the fraction portion is independently adjusted. The user interface communicates to the controller, such as by transmitting a signal to the controller, the at least one selected operating parameter. The controller activates the appliance to operate based on the selected operating parameter or the selected operating parameters. Upon completing the operation, a visual signal on the user interface and/or an audible signal are activated to indicate to the consumer that the operation is complete.

In this embodiment, an increment input component and/or a decrement input component is operatively coupled to an integer display portion of the display panel. The integer portion of the operating parameter is adjusted using the increment input component and/or the decrement input component. Similarly, an increment input component and/or a decrement input component is operatively coupled to a fraction display portion of the display panel. The fraction portion of the operating parameter is adjusted using the increment input component and/or the decrement input component.

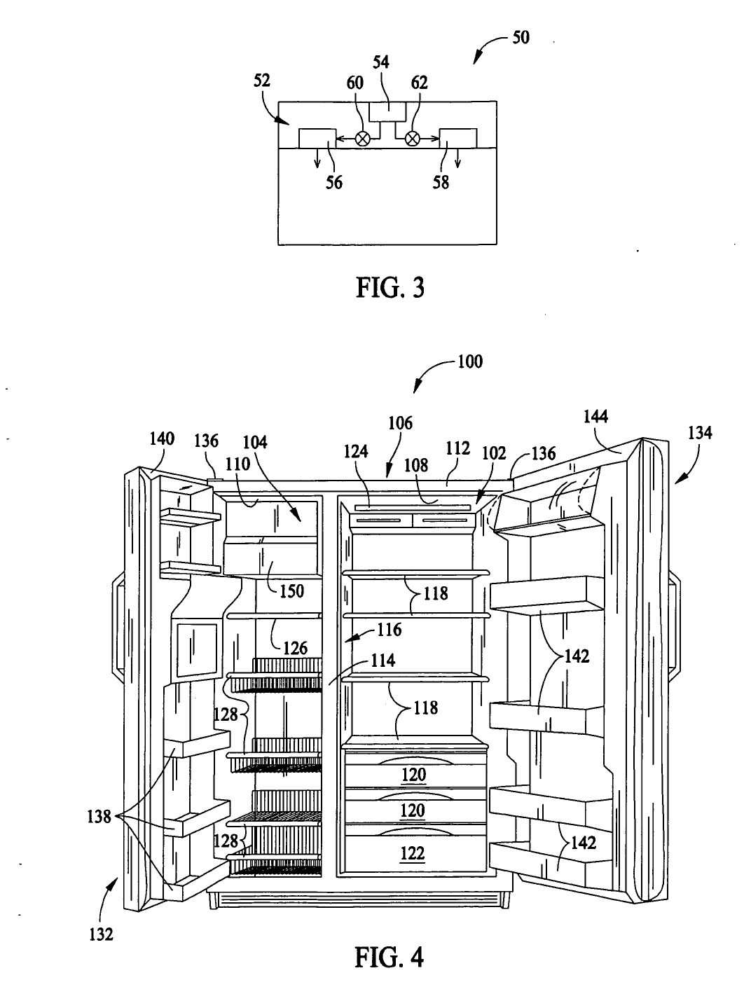

FIG. 3 is a schematic view of appliance 50 including a water dispensing system 52. Appliance 50 may be any household or commercial grade appliance having a need for water dispensing system 52 such as, but not limited to, a refrigerator, a laundry appliance such as a washing machine, a dishwashing appliance, a water treatment appliance, a water dispensing appliance, such as a countertop mounted water dispenser for delivering filtered water or hot water near a sink, and the like.

Water dispensing system 52 is coupled to appliance 50 for delivering and controlling an amount of water delivered to or from appliance 50. In one embodiment, water dispensing system 52 is programmable or variably selectable to deliver a predetermined amount of water. Water dispensing system 52 includes an inlet 54 coupled in flow communication with a plumbing supply line (not shown). Water dispensing system 52 also includes at least one outlet, such as a first outlet 56 and a second outlet 58. Valves 60 and 62 control the flow of water to outlets 56 and 58, respectively. In one embodiment, such as with the refrigerator or the water dispensing appliance, water is delivered to the user via outlets 56 and/or 58. In an alternative embodiment, such as with the laundry appliance or the dishwashing appliance, water is delivered into the cabinet of the appliance via outlets 56 and/or 58.

FIG. 4 illustrates an exemplary refrigerator 100. While the apparatus is described herein in the context of a specific refrigerator 100, it is contemplated that the herein described methods and apparatus may be practiced in other types of refrigerators, as well as other appliances. Therefore, as the benefits of the herein described methods and apparatus accrue generally to water dispensing controls in a variety of refrigeration appliances and machines, the description herein is for exemplary purposes only and is not intended to limit practice of the invention to a particular refrigeration appliance or machine, such as refrigerator 100.

Refrigerator 100 includes a fresh food storage compartment 102 and freezer storage compartment 104. Fresh food compartment 102 and freezer compartment 104 are arranged side-by-side, however, the benefits of the herein described methods and apparatus accrue to other configurations such as, for example, top and bottom mount refrigerator-freezers. Refrigerator 100 includes an outer case 106 and inner liners 108 and 110. A space between outer case 106 and inner liners 108 and 110, and between inner liners 108 and 110, is filled with foamed-in-place insulation. Outer case 106 normally is formed by folding a sheet of a suitable material, such as pre-painted steel, into an inverted U-shape to form top and side walls of case. A bottom wall of outer case 106 normally is formed separately and attached to the case side walls and to a bottom frame that provides support for refrigerator 100. Inner liners 108 and 110 are molded from a suitable plastic material to form freezer compartment 104 and fresh food compartment 102, respectively. Alternatively, inner liners 108, 110 may be formed by bending and welding a sheet of a suitable metal, such as steel. The illustrative embodiment includes two separate inner liners 108, 110 as it is a relatively large capacity unit and separate liners add strength and are easier to maintain within manufacturing tolerances. In smaller refrigerators, a single liner is formed and a mullion spans between opposite sides of the liner to divide it into a freezer compartment and a fresh food compartment.

A breaker strip 112 extends between a case front flange and outer front edges of liners. Breaker strip 112 is formed from a suitable resilient material, such as an extruded acrylo-butadiene-styrene based material (commonly referred to as ABS).

The insulation in the space between inner liners 108, 110 is covered by another strip of suitable resilient material, which also commonly is referred to as a mullion 114. Mullion 114 also, in one embodiment, is formed of an extruded ABS material. Breaker strip 112 and mullion 114 form a front face, and extend completely around inner peripheral edges of outer case 106 and vertically between inner liners 108, 110. Mullion 114, insulation between compartments, and a spaced wall of liners separating compartments, sometimes are collectively referred to herein as a center mullion wall 116.

Shelves 118 and slide-out drawers 120 normally are provided in fresh food compartment 102 to support items being stored therein. A bottom drawer or pan 122 is positioned within compartment 102. A shelf 126 and wire baskets 128 are also provided in freezer compartment 104. In addition, an ice maker 130 is provided in freezer compartment 104. Ice maker 130 is supplied with water by a dispenser assembly, such as, for example, water dispensing system 12 (shown in FIG. 3)

A freezer door 132 and a fresh food door 134 close access openings to fresh food and freezer compartments 102, 104, respectively. Each door 132, 134 is mounted by a top hinge 136 and a bottom hinge (not shown) to rotate about its outer vertical edge between an open position, as shown in FIG. 4, and a closed position (shown in FIG. 1) closing the associated storage compartment. Freezer door 132 includes a plurality of storage shelves 138 and a sealing gasket 140, and fresh food door 134 also includes a plurality of storage shelves 142 and a sealing gasket 144.

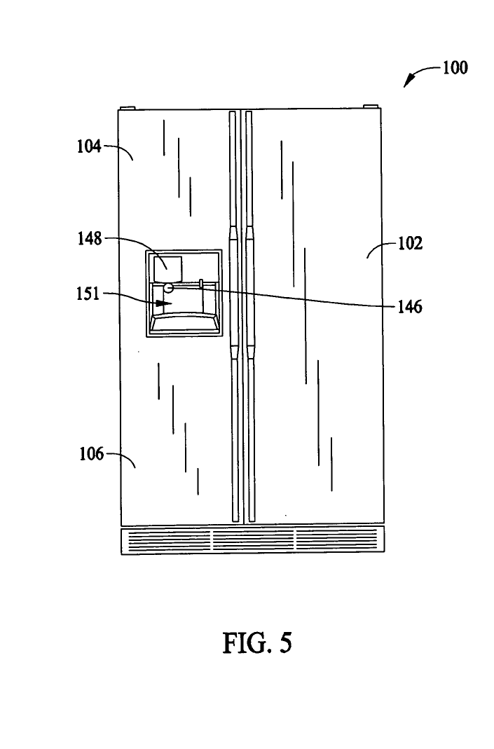

FIG. 5 is a front view of refrigerator 100 with doors 102 and 104 in a closed position. Freezer door 104 includes a through the door dispenser 146, and a user interface 148. Dispenser 146 is supplied water by a dispenser assembly, such as, for example, water dispensing system 52 (shown in FIG. 3). Additionally, dispenser 146 is supplied ice from ice maker 150 via a chute (not shown). In the exemplary embodiment, user interface 148 includes a display having touch screen capabilities. In alternative embodiments, user interface 148 includes a display and a separate input board with tactile buttons for a user to select various inputs. In one embodiment, refrigerator 100 includes a container sensor 151 proximate dispenser 146. Container sensor 151 senses the presence of a container, such as a cup, glass, bowl or other container, proximate dispenser 146 such that water or ice is dispensed into the container. The operation of dispenser 146 is prevented or discontinued if a container is not sensed by container sensor 149. In one embodiment, container sensor 149 is an optical sensor.

In use, and as explained in greater detail below, a user enters an input, such as, for example, a desired amount of water or a desired ice cube size, using interface 148, and the desired amount is dispensed by dispenser 146. For example, a recipe calls for certain amount of water (e.g., 5 ounces, 10 ounces, ⅓ cup, 2½ cups, 4¾ cups, 1 tablespoon, 2 teaspoons, etc.), and instead of using a measuring cup, the user can use any size container (large enough to hold the desired amount) by entering or selecting the desired amount using interface 148, and receiving the desired amount via dispenser 146. Dispenser 146 also dispenses ice cubes. A user may control a size of the ice cubes. In one embodiment, by selecting a smaller size ice cube, the ice cubes may be formed more quickly.

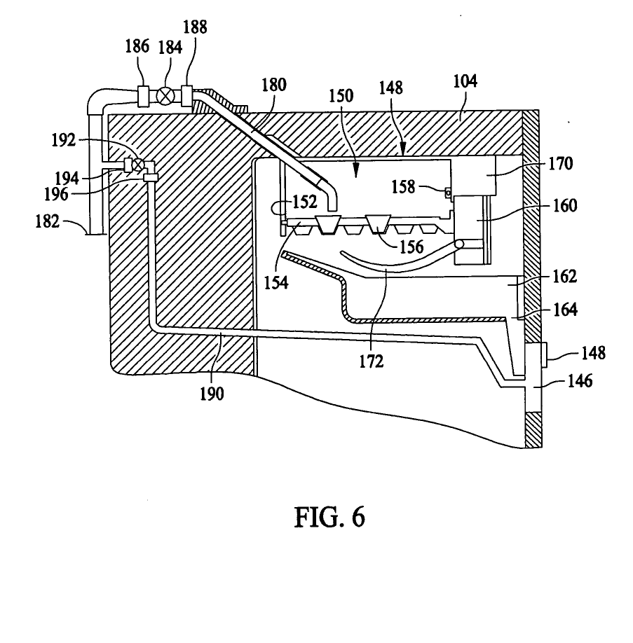

FIG. 6 is a partial sectional view of ice maker 150 including a water dispensing system. Ice maker 150 includes a metal mold 152 with a bottom wall 154 in which a plurality of cavities are defined to form ice pieces 156 when water flows successively to each cavity. In one embodiment, a water level detector 158 is mounted on an inner sidewall of ice maker 150 at a predetermined height to indicate the filled water level. To remove ice pieces 156 formed in the cavities in metal mold 152, bottom wall 154 is rotatably connected to a motor assembly 160 that reverses together with bottom wall 154 to get ice pieces 156 removed from cavities to a storage bucket 162 when ice pieces 156 are formed. Storage bucket 162 is located below ice maker 150. An outlet opening 164 is defined through the bottom of storage bucket 162 and is in communication with dispenser 146.

Operation of motor assembly 160 and ice maker 150 are effected by a controller 170 operatively coupled to motor assembly 160 and ice maker 150. Controller 170 operates ice maker 150 to refill mold 152 with water for ice formation after ice is harvested. In order to sense the level of ice pieces 156 in storage bucket 162, a sensor arm 172 is operatively coupled to controller 170 for controlling an automatic ice harvest so as to maintain a selected level of ice in storage bucket 162. Sensor arm 172 is rotatably mounted at a predetermined position on motor assembly 160 to sense a level of ice pieces 156 within storage bucket 162 into which ice pieces 156 are harvested and delivered from metal mold 152. Sensor arm 172 is automatically raised and lowered during operation of ice maker 150 as ice is formed. Sensor arm 172 is spring biased to a lower position that is used to determine initiation of a harvest cycle and raised by a mechanism (not shown) as ice is harvested to clear ice entry into storage bucket 162 and to prevent accumulation of ice above sensor arm 172 so that sensor arm 172 does not move ice out of storage bucket 162 as sensor arm 172 raises. When ice obstructs sensor arm 172 from reaching its lower position, controller 170 discontinues harvesting because storage bucket 162 is sufficiently full. As ice is removed from storage bucket 162, sensor arm 172 gradually moves to its lower position, thereby indicating a need for more ice and causing controller 170 to initiate a fill operation as described in more detail below.

To supply water to ice maker 150 for making ice, first water dispenser 180 is in communication with a water source 182 and ice maker 150. A first water valve 184 is coupled to first water dispenser 180 and is also operatively coupled to controller 170. A sensor 186, such as, for example, a flow meter, is used to detect a volume of water flowing through water dispenser 180 into ice maker 150. In one embodiment, flow meter 186 is an axial flow meter, wherein water flows through flow meter 186 along an axis of rotation of the blades of flow meter 186. In an alternative embodiment, flow meter 186 is a radial flow meter, wherein water flows through flow meter 186 generally perpendicular to an axis of rotation of the blades of flow meter 186. In further alternative embodiments, flow meter 186 is a turbine rate meter, a thermal mass sensor, a pressure differential sensor, a flow washer, an electromagnetic sensor, an ultrasonic sensor, or the like. Flow meter 186 is coupled to water source 182, water valve 184 and/or the outlet into ice maker 150. Flow meter 186 is configured to measure the amount of water passing through flow meter 186. Flow meter 186 is also operatively coupled to controller 170, which is configured to receive a signal indicating the quantity of water passing though flow meter 186. A second sensor 188, such as, for example, a pressure sensor, is also used to measure the pressure of the water flowing past flow meter 186. Pressure sensor 188 may be positioned immediately upstream of, immediately downstream of, or remote with respect to flow meter 186 for detecting the pressure of the water.

In one embodiment, a second water dispenser 190 is in communication with water source 182 and dispenser 146. A second water valve 192 is coupled to second water dispenser 190 and is operatively coupled to controller 170. Second water valve 192 controls the flow of water through second water dispenser 190. A sensor 194, such as, for example, a flow meter, is configured to measure the amount of water flowing through second water dispenser 190. In one embodiment, flow meter 194 is an axial flow meter, wherein water flows through flow meter 194 along an axis of rotation of the blades of flow meter 194. Flow meter 194 is also operatively coupled to controller 170, which is configured to receive a signal indicating the quantity of water passing though flow meter 194. Controller 170 may operate valve 192 based upon the signal from flow meter 194. Flow meter 194 is coupled to water source 182, water valve 184 and/or the outlet at dispenser 146. As such, in one embodiment, a single flow meter 186 or 194 may be used to measure the amount of water channeled to first water dispenser 180 and second water dispenser 190, such as, for example, by coupling flow meter 186 proximate water source 182. Alternatively, multiple flow meters 186 and 194 are used to independently measure the flow through first water dispenser 180 and second water dispenser 190, respectively. A second sensor 196, such as, for example, a pressure sensor, is also used to measure the pressure of the water flowing past flow meter 194. Pressure sensor 196 may be positioned immediately upstream of, immediately downstream of, or remote with respect to flow meter 194 for detecting the pressure of the water.

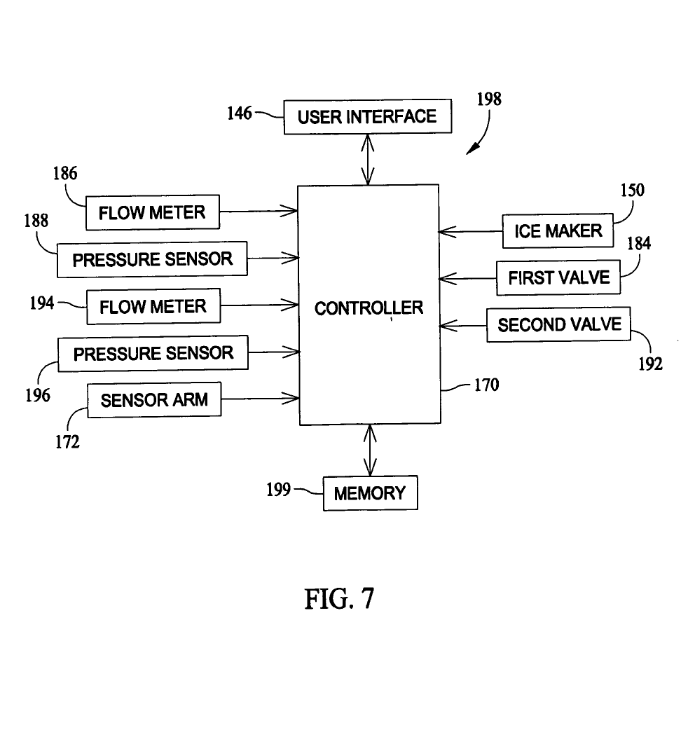

FIG. 7 is a control system 198 for use with refrigerator 100 shown in FIGS. 4-6. Controller 170 is operatively coupled to flow meters 186 and 194, pressure sensors 188 and 196, user interface 148, water level detector 158, sensor arm 172, first water valve 184, second water valve 192 and a memory element 199. Controller 170 is programmed to operate the above mentioned components. In one embodiment, controller 170 can be implemented as a microprocessor. As described above, the term microprocessor as used hereinafter is not limited just to microprocessors, but broadly refers to computers, processors, microcontrollers, microcomputers, programmable logic controllers, application specific integrated circuits and other programmable logic circuits, and these terms are used interchangeably herein.

In one embodiment, each flow meter 186 and 194 includes a rotating element (not shown), a magnet (not shown) mounted to the rotating element, and a circuit with a reed switch (not labeled) placed relative to the rotating element such that every time a magnet passes close to the reed switch, a circuit is completed and a pulse is generated. A programmable logic controller (PLC) with a high speed counter (not labeled) is utilized with the reed switch such that an exact amount of water passing through flow meter 186 can be calculated.

In use, water can be dispensed into ice maker 150 in different modes. In a first mode, a user can select a predetermined amount of water dispensed into ice maker 150. Specifically, the user enters a desired amount of water or a desired ice cube size using user interface 148. Controller 170 then initiates a water fill into ice maker 150 from water source 182, through flow meter 186 and first water valve 184. As flow meter 186 senses that the quantity of water reaches the preselected amount, a signal is sent to controller 170. Controller 170 then sends a signal to first water valve 184 to close. As such, no more water is supplied to ice maker 150. Afterwards, a predetermined size of ice cubes will be made, since the size of ice pieces or ice cubes depends on the amount of water supplied into metal mold 152 of ice maker 150. As a result, under-filling or over-filling of the ice maker will be avoided. In addition, the user can obtain the desired size of ice pieces.

In a second mode, the user may select a continuous fill, wherein controller 170 will command water valve 184 to open, thereby allowing water to flow into ice maker 150 continuously until water level detector 158 informs controller 170 that the water level in ice maker 150 has reached an upper limit. Then, controller 170 will instruct water valve 184 to close to prevent any water from being supplied.

In an alternative embodiment, a measured volume of water is dispensed from dispenser 146 by second water dispenser 190. For example, a recipe calls for a certain volume of water (e.g., a teaspoon, a table spoon, 5 ounces, 10 ounces, ¼ cup, ⅓ cup, ½ cup, 1⅔ cups, 2¾ cups, etc.), and instead of using a measuring cup, the user can use any size container (large enough to hold the desired amount). The user enters or selects the desired volume using user interface 148 in a measured fill mode. Then, controller 170 opens second water valve 192, allowing water to flow into the container. In a normal dispense mode, the user may desire a continuous flow of water to dispenser 146. Controller 170 leaves valve 192 open until the user stops demanding water.

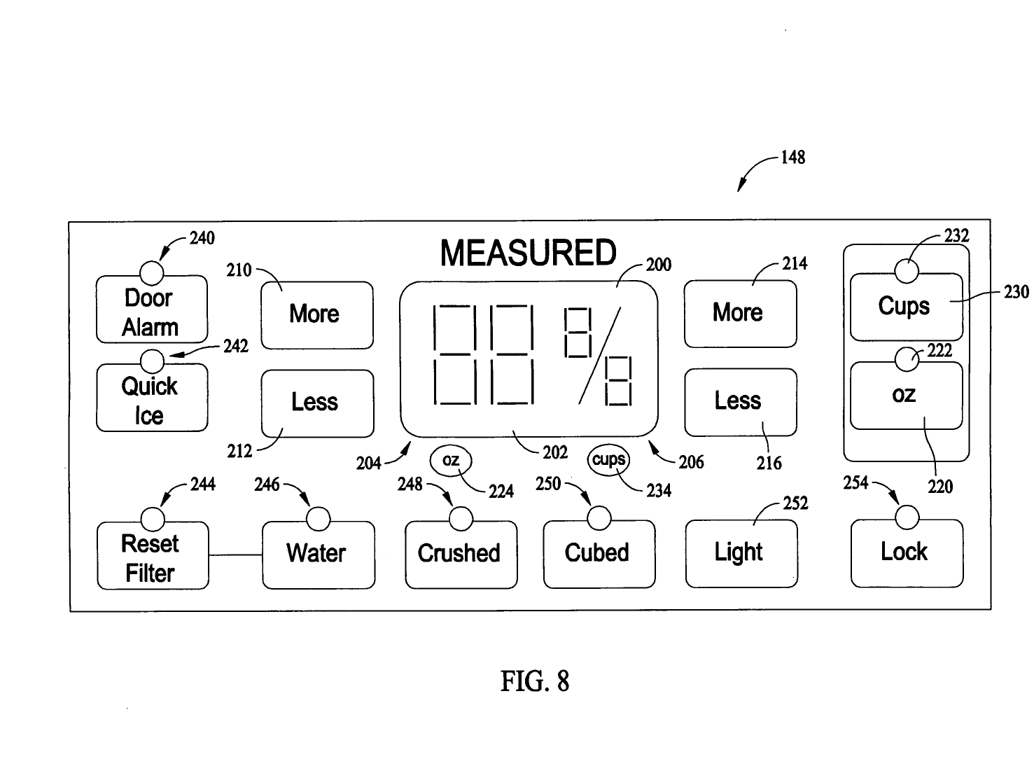

Referring further to FIG. 8, in one embodiment user interface 148 is configured for selecting a measured volume of water to dispense from second water dispenser 190. Second water dispenser 190 is operatively coupled to controller 170, which is configured to measure the volume of water selected to dispense from second water dispenser 190. As shown in FIG. 8, user interface 148 includes a display panel 200 including a measured fill display 202. Measured fill display 202 has an integer display portion 204 and a fraction or decimal display portion 206. Display panel 200 is configured to independently select and/or adjust an integer portion of the volume of water to dispense and a fraction portion of the volume of water to dispense. Further, display panel 200 is in communication with controller 170 and is configured to transmit a signal to controller 170 indicating the selected volume of water to dispense.

In one embodiment, user interface 148 includes at least one input component, such as at least one button, for facilitating selecting and/or adjusting a volume of water to be dispensed. In a particular embodiment, user interface 148 includes an increment button 210 and/or a decrement button 212. Increment button 210 and/or decrement button 212 are operatively coupled to integer display portion 204 and are configured to select and/or adjust the integer portion of the volume of water to dispense, as described in greater detail below. In this embodiment, an increment button 214 and/or a decrement button 216 are operatively coupled to fraction display portion 206 and are configured to select and/or adjust the fraction portion of the volume of water to dispense.

User interface 148 includes at least input component, such as at least one button, configured to select a unit of measurement operating mode. In one embodiment, user interface 148 includes a first unit of measurement selection button 220, as shown in FIG. 8, corresponding to a first unit of measurement operating mode. In a particular embodiment, the first unit of measurement operating mode is configured to measure the volume of water in ounce units. Upon pressing selection button 220 to select the first unit of measurement operating mode, integer display portion 202 displays the selected ounce units, between and including a range of “1” ounce and “99” ounces. Additionally, a suitable indicator, such as a LED indicator 222 and/or 224, indicates that the first unit of measurement operating mode has been selected. In this particular embodiment, with the first unit of measurement operating mode selected, fraction display portion 206 displays a blank display screen. Increment button 210 and/or decrement button 212 is pressed to select the desired number of ounce units of water to be dispensed. The selected number of ounce units is displayed within integer display portion 204.

Additionally, user interface 148 includes a second unit of measurement selection button 230, as shown in FIG. 8, corresponding to a second unit of measurement operating mode. In a particular embodiment, the second unit of measurement operating mode is configured to measure the volume of water in cup units. Upon pressing selection button 230 to select the second unit of measurement operating mode, integer display portion 204 displays the selected integer cup units, between and including a range of “0” cups (indicated by a blank display screen) and “16” cups. In this particular embodiment, the desired integer cup units are adjusted by increments or decrements of 1 cup unit. Fraction display portion 206 displays the selected fraction cup units including, without limitation, “0” (indicated by a blank display screen), “⅛”, “¼”, “⅓”, “⅜”, “½”, “⅝”, “⅔”, “¾”, or “⅞”. In an alternative embodiment, fraction display portion 206 displays the selected fraction cup units in decimal configuration, such as within a range of “0.01” and “0.99”. Additionally, a suitable indicator, such as a LED indicator 232 and/or 234, indicates that the second unit of measurement operating mode has been selected.

In this embodiment, increment button 210 and/or decrement button 212 is pressed to select the desired number of integer cup units of water to be dispensed. The selected number of integer cup units is displayed within integer display portion 204. Similarly, increment button 214 and/or decrement button 216 is pressed to select the desired fraction cup unit of water to be dispensed. The selected fraction cup unit is displayed within fraction display portion 206.

It is apparent to those skilled in the art and guided by the teachings herein provided that user interface 148 may include any suitable number of unit of measurement operating modes capable of measuring any desired volume of dispensed water in any desired unit of measurement. Further, in alternative embodiments, user interface 148 includes any suitable button or other input component, as described above in reference to FIGS. 1 and 2, and/or corresponding indicator operatively coupled to controller 170 for controlling operation of refrigerator 100. As shown in FIG. 8, user interface 148 may include a door alarm button and/or indicator 240, a quick ice button and/or indicator 242, a reset filter button and/or indicator 244, a water selection button and/or indicator 246, a crushed ice selection button and/or indicator 248, a cubed ice selection button and/or indicator 250, a light button 252 and/or a lock button and/or indicator 254, in alternative embodiments.

In one embodiment, appliance 10, such as refrigerator 100, includes water dispenser 190 including water valve 192 operatively coupled to controller 170 for controlling a flow of water through water dispenser 190 and flowmeter 194 for measuring a volume of water dispensed through water dispenser 190. Controller 170 is operatively coupled to water valve 192 and flowmeter 194. In one embodiment, controller 170 is configured to activate water dispenser 190 to dispense a measured volume of water. User interface 148 is configured to select the measured volume of water to dispense from water dispenser 190. In one embodiment, user interface 148 includes display panel 200. Display panel 200 includes measured fill display 202 including integer display portion 204 and fraction display portion 206. Display panel 200 is configured to independently select an integer portion of the volume of water to dispense and a fraction portion of the volume of water to dispense. Display panel 200 is in communication with controller 170 and is configured to transmit a signal to controller 170 indicating the selected volume of water. Upon the user selecting the volume of water to be dispensed from water dispenser 190, controller 170 activates water dispenser 190 to dispense the measured volume of water.

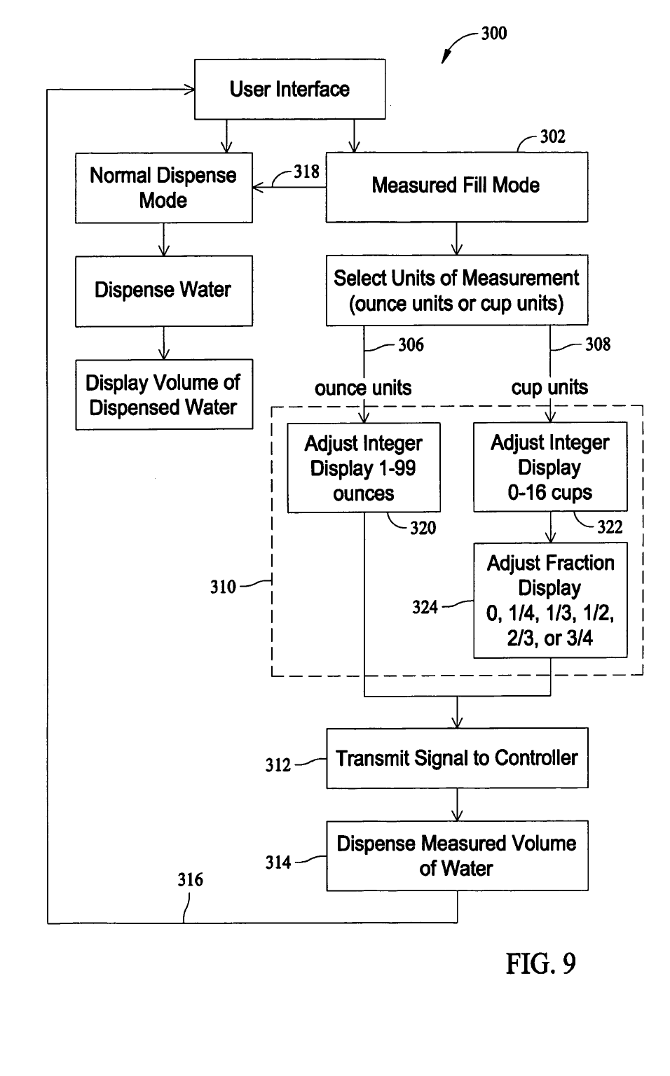

Referring to FIG. 9, in one embodiment, a method is provided for dispensing 300 a measured volume of water from a water dispensing system. The method includes activating 302 a measured fill mode on user interface 148. In one embodiment, user interface 148 is capable of operating in a normal dispense mode or a measured fill mode, as described above. In a particular embodiment, the measured fill mode is activated 302 by pressing a button positioned within the measured fill area of display panel 200, such as increment button 210, decrement button 212, increment button 214, decrement button 216, first unit of measurement selection button 220 or second unit of measurement selection button 230. In one embodiment, upon activation of the measured fill mode, a last-used unit of measurement operating mode and/or a last-used selected volume is displayed on display panel 200.

Within the measured fill mode, the user selects 304 a unit of measurement operating mode. In one embodiment, when the user presses 306 first unit of measurement selection button 220 to select the first unit of measurement operating mode, for example, indicators 222 and 224 light or turn on and indicators 232 and 234 turn off. Alternatively, when the user presses 308 second unit of measurement selection button 230 to select the second unit of measurement operating mode, for example, indicators 232 and 234 light or turn on and indicators 222 and 224 turn off. In this embodiment, an indicator, such as LED indicators 222 and/or 224, operatively coupled to first unit of measurement selection button 220, or LED indicators 232 and/or 234, operatively coupled to second unit of measurement selection button 230, indicate the selected unit of measurement operating mode.

Depending upon the unit of measurement operating mode selected by the user, an integer portion and/or a fraction portion of a volume of water to dispense from the water dispensing system are independently adjusted 310. The adjusted integer portion and/or the adjusted fraction portion are displayed on display panel 200 of user interface 148. With the measured volume of water to dispense selected, user interface 148 is configured to transmit 312 a suitable signal to controller 170 in operational communication with user interface 148. The signal indicates the selected volume of water to dispense from the water dispensing system. Upon receiving the signal from user interface 148, controller 170 activates dispenser 190 to dispense 314 the measured volume of water. In one embodiment, a switch or sensor, such as container sensor 151, is depressed or activated to dispense the selected volume of water. Upon completing dispensing the selected volume of water, a “0” is displayed on display panel 200 and/or an audible signal is activate to alert the user that the measured fill is completed. Within a suitable time period, such as about one (1) second in one embodiment, the measured fill mode is reset 316 to the normal dispense mode.

In one embodiment, when the dispensing of the measured volume of water is interrupted, a remaining volume of water to be dispensed is displayed for a selected time period, such as about five (5) seconds in one embodiment. Upon activation of container sensor 151 within the selected time period, such as by positioning a container with respect to dispenser 164, the measured fill is continued. However, if the container switch or sensor remains inactivated during the selected time period, display panel 200 is reset to the selected volume of water. Additionally, the measured fill mode is deactivated 318 after an idle time period, such as about fifteen (15) seconds in one embodiment, and user interface 148 is defaulted to the normal dispense mode. In the normal dispense mode, controller 170 activates dispenser 190 to dispense water, as desired by the user, and display panel 200 indicates a volume of water dispensed.

In one embodiment, when the first unit of measurement operating mode is selected 306, the integer display portion of display panel 200 is activated to display the integer portion of the water to be dispensed. The integer portion is adjusted 320 to select a desired number of ounce units to be dispensed. In this embodiment, the number of ounce units is selected within a range of “1” ounce and “99” ounces by an increment or decrement of 1 ounce unit. Alternatively, when the second unit of measurement operating mode is selected 308, the integer display portion and the fraction display portion of display panel 200 are activated. The integer portion of the water to be dispensed is adjusted 322 within a range of “0” cups (indicated by a blank screen on integer display portion 204) and “16” cups by an increment or decrement of 1 cup unit. Additionally or alternatively, the fraction portion of the water to be dispensed is adjusted 324 to “0” (indicated by a blank screen on fraction display portion 206), “⅛”, “¼”, “⅓”, “⅜”, “⅝”, “⅔”, “ 3/4”, or “⅞”, for example. Alternatively, the fraction portion of the water to be dispensed is adjusted in decimal configuration within a range of “0.01” and “0.99”, for example. In one embodiment, increment button 210 and/or decrement button 212, each operatively coupled to integer display portion 204 of display panel 200, are pressed for selecting the integer portion of the volume of water to dispense. Similarly, increment button 214 and/or decrement button 216, each operatively coupled to fraction display portion 206 of display panel 200, are pressed for selecting the fraction portion of the volume of water to dispense.

The above-described user interface of the present invention provides the user with the ability to select and/or adjust an operating parameter for operation of an appliance in an efficient matter. More specifically, the user interface of the present invention provides the user with the ability to independently select an integer portion of the selected operating parameter and/or a fraction or decimal portion of the selected operating parameter. Further, the user interface provides a user with selective operating modes for facilitating operating the appliance, as desired by the consumer.

Exemplary embodiments of an apparatus and method for selecting and/adjusting an operating parameter for operation of an appliance are described above in detail. The apparatus and method is not limited to the specific embodiments described herein, but rather, components of the apparatus and/or steps of the method may be utilized independently and separately from other components and/or steps described herein. Further, the described apparatus components and/or method steps can also be defined in, or used in combination with, other apparatus and/or methods, and are not limited to practice with only the apparatus and method as described herein.

While the invention has been described in terms of various specific embodiments, those skilled in the art will recognize that the invention can be practiced with modification within the spirit and scope of the claims.

What is claimed is:

1. A user interface for an appliance, said user interface operatively coupled to a controller configured to control operation of the appliance in a consumer input mode wherein at least one operating parameter is selectable by the consumer, said user interface comprising:
a display panel having an integer display portion and a fraction display portion, said user interface configured to independently select an integer portion of the at least one operating parameter and a fraction portion of the at least one operating parameter, said user interface in operational communication with the controller and configured to transmit a signal to the controller indicating the at least one selected operating parameter.

2. A user interface in accordance with claim 1 further comprising at least one input component operatively coupled to said integer display portion and configured to select said integer portion of the at least one operating parameter.

3. A user interface in accordance with claim 1 further comprising at least one indicator operatively coupled to said at least one input component and configured to indicate a selected operating mode.

4. A user interface in accordance with claim 1 further comprising at least one input component operatively coupled to said fraction display portion and configured to select said fraction portion of the at least one operating parameter.

5. A user interface in accordance with claim 1 further comprising at least one input component configured to select a unit of measurement operating mode.

6. A user interface in accordance with claim 1. wherein said integer display portion displays one of a blank screen and an integer.

7. A user interface in accordance with claim 1 wherein said fraction display portion displays one of a blank screen, a decimal and a fraction.

8. An appliance comprising:
a cabinet;
a user interface coupled to said cabinet and configured for selection of at least one operating parameter in a consumer input mode, said user interface comprising:
a display panel having an integer display portion and a fraction display portion, said user interface configured to independently select an integer portion of the at least one operating parameter and a fraction portion of the at least one operating parameter; and
a controller in operational communication with said user interface, said controller configured to control operation of the appliance in response to the at least one operating parameter selected by the consumer.

9. An appliance in accordance with claim 8 wherein said user interface is configured to transmit at least one signal to said controller indicating the at least one selected operating parameter.

10. An appliance in accordance with claim 8 wherein said user interface further comprises:
at least one first input component operatively coupled to said integer display portion and configured to select said integer portion of the at least one operating parameter; and
at least one second input component operatively coupled to said fraction display portion and configured to select said fraction portion of the at least one operating parameter.

11. An appliance in accordance with claim 10 wherein said at least one first input component further comprises at least one of an increment input component and a decrement input component operatively coupled to said integer display portion and configured to select said integer portion.

12. An appliance in accordance with claim 10 wherein said at least one second input component further comprises at least one of an increment input component and a decrement input component operatively coupled to said fraction display portion and configured to select said fraction portion.

13. An appliance in accordance with claim 10 further comprising at least one indicator operatively coupled to at least one of said at least one first input component and said at least one second input component, said at least one indicator configured to indicate a selected operating mode.

14. An appliance in accordance with claim 8 further comprising at least one input component configured to select said at least one operating parameter.

15. An appliance in accordance with claim 8 wherein said appliance comprises one of a microwave, a range, a refrigerator, a washing machine, a dryer and a dishwasher.

16. A method for selecting at least one operating parameter of an appliance in a consumer input mode, said method comprising:
displaying at least one of an integer portion and a fraction portion of the at least one operating parameter on a display panel of a user interface, the user interface in operational communication with a controller configured to control operation of the appliance;
independently adjusting at least one of the integer portion and the fraction portion; and
transmitting a signal to the controller, the signal indicating the at least one selected operating parameter.

17. A method in accordance with claim 16 further comprising:
activating the consumer input mode on the user interface; and
selecting the at least one operating parameter from a plurality of operating parameters indicated on the user interface.

18. A method in accordance with claim 16 further comprising indicating at least one of a last-used operating mode and a last-used selected operating parameter upon activating the consumer input mode.

19. A method in accordance with claim 16 further comprising indicating on the user interface the at least one selected operating parameter.

20. A method in accordance with claim 16 further comprising activating the appliance to operate based on the at least one selected operating parameter.

21. A method in accordance with claim 20 wherein, upon completing the operation, the method further comprises activating at least one of a visual signal on the user interface and activating an audible signal to indicate to the consumer that the operation is complete.

22. A method in accordance with claim 16 wherein independently selecting at least one of an integer portion and a fraction portion further comprises pressing at least one of an increment input component and a decrement input component operatively coupled to an integer display portion of the display panel.

23. A method in accordance with claim 16 wherein independently selecting at least one of an integer portion and a fraction portion further comprises pressing at least one of an increment input component and a decrement input component operatively coupled to a fraction display portion of the display panel.
